(19) United States
(12) Patent Application Publication
(10) Pub. No.: US 2023/0199896 A1
(43) Pub. Date: Jun. 22, 2023

(54) METHOD AND APPARATUS FOR TRANSFERRING SERVICE, COMMUNICATION DEVICE AND STORAGE MEDIUM

(71) Applicant: BEIJING XIAOMI MOBILE SOFTWARE CO., LTD., Beijing (CN)

(72) Inventor: Xing YANG, Beijing (CN)

(73) Assignee: BEIJING XIAOMI MOBILE SOFTWARE CO., LTD., Beijing (CN)

(21) Appl. No.: 17/924,605

(22) PCT Filed: May 15, 2020
(86) PCT No.: PCT/CN2020/090692

§ 371 Date: Nov. 10, 2022

(51) Int. Cl. H04W 76/22; H04L 5/00; H04W 72/12; H04W 72/50

(52) U.S. Cl. CPC H04W 76/22; H04L 5/0048; H04W 72/1221; H04W 72/535

(57) ABSTRACT

A method for transferring a service, performed by a first terminal, and including: in response to determining that a service switch condition is met, transferring service data to be transmitted between the first terminal and a base station, such that the service data is transmitted between the first terminal and a second terminal, the second terminal is operating as a relay terminal enabling communication between the first terminal and the base station.

### CROSS REFERENCE TO RELATED APPLICATION

The present application is a U.S. National Stage of International Application No. PCT/CN2020/090692, filed on May 15, 2020, the entire content of which is incorporated herein by reference for all purposes.

### BACKGROUND

In order to support direct communication between terminals, a sidelink communication mode is introduced. An interface between the terminals is PC-5. According to a corresponding relationship between a sending terminal and a receiving terminal, a sidelink supports three transmission modes, namely unicast, multicast and broadcast. One terminal may communicate with a base station through relay of another terminal without directly connecting with the base station. A terminal not connected with the base station is called a remote terminal (remote UE); a terminal providing a relay function is called a relay terminal (relay UE); and the remote terminal communicates with the relay terminal through the sidelink.

### SUMMARY

According to a first aspect of the disclosure, a method for transferring a service is provided, performed by a first terminal, and including:

in response to determining that a service switch condition is met, transferring service data to be transmitted between the first terminal and a base station, such that the service data is transmitted between the first terminal and a second terminal, the second terminal is operating as a relay terminal enabling communication between the first terminal and the base station.

According to a second aspect of the disclosure, a method for transferring a service is provided, performed by a base station, and including:

sending a service switch condition to a first terminal, where

the service switch condition is configured to: trigger the first terminal to transfer, in response to determining that the service switch condition is met, service data to be transmitted between the first terminal and the base station, such that the service data is transmitted between the first terminal and a second terminal, the second terminal is operating as a relay terminal enabling communication between the first terminal and the base station.

According to a third aspect of the disclosure, a communication device is provided, including:

a processor; and

a memory for storing executable instructions of the processor; where

the processor is configured to: implement the method described in any example of the disclosure when running the executable instructions.

### BRIEF DESCRIPTION OF THE DRAWINGS

FIG. 1 is a schematic structural diagram of a wireless communication system.

FIG. 2 is a schematic diagram of a wireless communication system shown according to an example.

FIG. 3 is a flow diagram of a method for transferring a service shown according to an example.

FIG. 4 is a schematic diagram of a method for transferring a service shown according to an example.

FIG. 5 is a flow diagram of a method for transferring a service shown according to an example.

FIG. 6 is a flow diagram of a method for transferring a service shown according to an example.

FIG. 7 is a flow diagram of a method for transferring a service shown according to an example.

FIG. 8 is a flow diagram of a method for transferring a service shown according to an example.

FIG. 9 is a flow diagram of a method for transferring a service shown according to an example.

FIG. 10 is a flow diagram of a method for transferring a service shown according to an example.

FIG. 11 is a flow diagram of a method for transferring a service shown according to an example.

FIG. 12 is a flow diagram of an apparatus for transferring a service shown according to an example.

FIG. 13 is a flow diagram of an apparatus for transferring a service shown according to an example.

FIG. 14 is a block diagram of user equipment shown according to an example.

FIG. 15 is a block diagram of a base station shown according to an example.

### DETAILED DESCRIPTION

Examples will be illustrated in detail here, and instances of which are represented in accompanying drawings. When the following description refers to the accompanying drawings, the same number in the different accompanying drawings represents the same or similar elements unless otherwise indicated. The implementations described in the following examples do not represent all implementations consistent with the examples of the disclosure. On the contrary, they are merely examples of an apparatus and method consistent with some aspects of the examples of the disclosure as detailed in the appended claims.

The terms used in the examples of the disclosure are merely for the purpose of describing the particular examples, and are not intended to limit the examples of the disclosure. The singular forms “a” and “this” used in the examples of the disclosure and the appended claims are intended to include the plural forms as well, unless the context clearly indicates otherwise. It is supposed to be further understood that the term “and/or” used here refers to and contains any and all possible combinations of one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It is supposed to be understood that the terms “first”, “second”, “third” and the like may be employed in the examples of the disclosure to describe various information, but the information is not supposed to be limited to these terms. These terms are merely used to distinguish the same type of information from one another. For example, in a case of not departing from the scope of the examples of the disclosure, first information may also be called second information, and similarly, the second information may also be called the first information. Depending on the context, the word “if” as used here may be interpreted as “at the time of” or “when” or “in response to determining”.

For the purpose of conciseness and easy understanding, the terms used here when characterizing a size relationship are “greater than” or “less than”. However, for those skilled in the art, it may be understood that based on the corresponding technical scenario and technical solution, the term “greater than” may also cover the meaning of “greater than or equal to”, and “less than” may also cover the meaning of “less than or equal to”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The disclosure relates to the technical field of wireless communications, but is not limited to the technical field of wireless communications, in particular to a method and apparatus for transferring a service, a communication device and a storage medium.

In order to support direct communication between terminals, a sidelink communication mode is introduced. An interface between the terminals is PC-5. According to a corresponding relationship between a sending terminal and a receiving terminal, a sidelink supports three transmission modes, namely unicast, multicast and broadcast. One terminal may communicate with a base station through relay of another terminal without directly connecting with the base station. A terminal not connected with the base station is called a remote terminal (remote UE); a terminal providing a relay function is called a relay terminal (relay UE); and the remote terminal communicates with the relay terminal through the sidelink.

When the terminal leaves network coverage, in order to maintain connection with a network, the base station will transfer a service of the terminal to the relay terminal. The base station will send a radio resource control (RRC) message to the terminal. The radio resource control (RRC) message is configured to instruct the terminal to transfer the service to a target relay terminal. However, channel quality between the terminal and the base station changes. In this way, when the channel quality changes and transmission of service data needs to be transferred, how to transfer the transmission of the service data as soon as possible, on the one hand to ensure the communication quality, on the other hand to reduce delay, is a problem needing to be further solved in the related art.

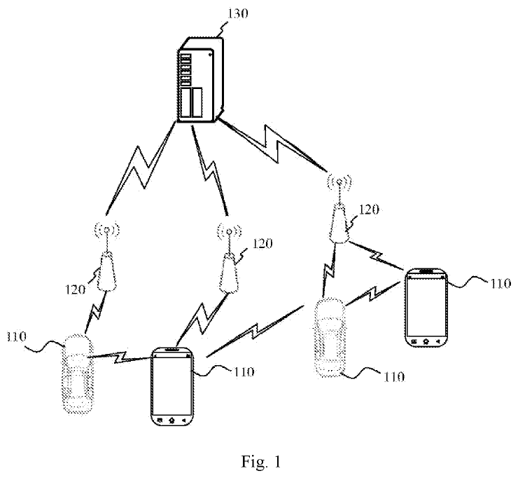

Please refer to FIG. 1, which shows a schematic structural diagram of a wireless communication system provided by an example of the disclosure. As shown in FIG. 1, the wireless communication system is a communication system based on a cellular mobile communication technology, and the wireless communication system may include: a plurality of user equipment 110 and a plurality of base stations 120.

The user equipment 110 may refer to a device that provides voice and/or data connectivity for a user. The user equipment 110 may communicate with one or more core networks via a radio access network (RAN), and the user equipment 110 may be Internet of Thing user equipment, such as a sensor device, a mobile phone (or called a “cellular” phone) and a computer with the Internet of Thing user equipment, for example, may be fixed, portable, pocket-sized, hand-held, computer-built or vehicle-mounted apparatuses. For example, the user equipment may be a station (STA), a subscriber unit, a subscriber station, a mobile station, a mobile, a remote station, an access point, remote user equipment (remote terminal), access user equipment (access terminal), a user apparatus (user terminal), a user agent, a user device, or the user equipment. Alternatively, the user equipment 110 may also be a device of an unmanned aerial vehicle. Alternatively, the user equipment 110 may also be a vehicle-mounted device, for example, a trip computer with a wireless communication function, or wireless user equipment externally connected to the trip computer. Alternatively, the user equipment 110 may also be a roadside device, for example, may be a streetlight, a signal light, or other roadside devices with the wireless communication function.

The base station 120 may be a network-side device in the wireless communication system. The wireless communication system may be the 4th generation mobile communication (4G) system, also known as a long term evolution (LTE) system; alternatively, the wireless communication system may also be a 5G system, also known as a new radio system or a 5G NR system. Alternatively, the wireless communication system may also be the next-generation system of the 5G system. An access network in the 5G system may be called a new generation-radio access network (NG-RAN).

The base station 120 may be an evolved base station (eNB) employed in the 4G system. Alternatively, the base station 120 may also be a base station (gNB) that employs a centralized distributed architecture in the 5G system. In response to determining that the base station 120 employs the centralized distributed architecture, the base station usually includes a central unit (CU) and at least two distributed units (DU). The central unit is internally provided with protocol stacks of a packet data convergence protocol (PDCP) layer, a radio link control (RLC) protocol layer, and a media access control (MAC) layer; and the distributed unit is internally provided with a physical (PHY) layer protocol stack. The specific implementation of the base station 120 is not limited in the examples of the disclosure.

A wireless connection may be established between the base station 120 and the user equipment 110 through a wireless radio. In different implementations, the wireless radio is a wireless radio based on the 4th generation mobile communication network technology (4G) standard; alternatively, the wireless radio is a wireless radio based on the 5th generation mobile communication network technology (5G) standard, for example, the wireless radio is a new radio; alternatively, the wireless radio may also be a wireless radio based on the next generation of 5G mobile communication network technology standard.

In some examples, an end to end (E2E) connection may also be established between the user equipment 110, for example, vehicle to vehicle (V2V) communication, vehicle to infrastructure (V2I) communication, vehicle to pedestrian (V2P) communication and other scenarios in vehicle to everything (V2X) communication.

Here, the above user equipment may be regarded as terminal equipment of the following examples.

In some examples, the above wireless communication system may further contain a network management device 130.

The plurality of base stations 120 are respectively connected with the network management device 130. The network management device 130 may be a core network device in the wireless communication system. For example, the network management device 130 may be a mobility management entity (MME) in an evolved packet core (EPC) network. Alternatively, the network management device may also be other core network devices, such as a serving gateway (SGW), a public data network gateway (PGW), a policy and charging rules function (PCRF) or a home subscriber server (HSS). An implementation form of the network management device 130 is not limited in the example of the disclosure.

In order to facilitate understanding of any example of the disclosure, a cell handover scenario and a terminal service transfer scenario are first illustrated through one example.

In order to improve robustness of cell handover, the 5th generation mobile communication technology (5G) proposes a conditional handover (CHO) process. That is, the network can configure a trigger condition of handover between a handover target cell and a cell for the terminal in advance. In response to determining that the handover trigger condition is met, the terminal may initiate the handover process by itself to hand over to the target cell, and the network does not need to send a handover command again. The network may configure one or more handover conditions of handover target cells for the terminal. The handover conditions include A3 and A5 events. The A3 event is: channel quality of a neighbor cell is higher than a serving cell by a certain value. The A5 event is: the channel quality of the neighbor cell is higher than a certain threshold and channel quality of the serving cell is lower than a certain threshold.

Here, when selecting the cell, the terminal will select a suitable cell to reside. The suitable cell is a cell whose wireless signal quality is higher than a set threshold and belongs to a public land mobile network (PLMN) selected by the terminal.

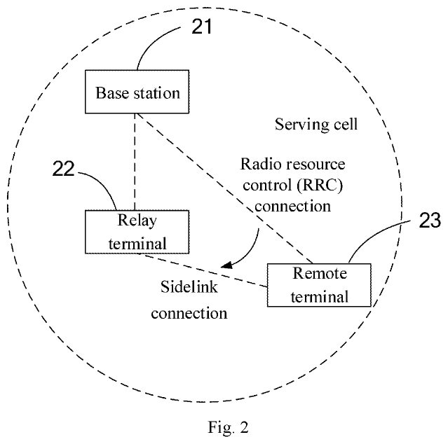

As shown in FIG. 2, the wireless communication system includes a base station 21, a relay terminal 22, and a remote terminal 23. When the remote terminal is located at an edge of the serving cell or leaves the serving cell, service data of the remote terminal will be changed from transmission between the base station and the remote terminal to transmission between the relay terminal and the remote terminal.

Here, on the one hand, when transferring the service to the relay terminal, if only a signal intensity is considered, the terminal may be triggered to transfer the service to the relay terminal in an area where the service cell has coverage vulnerability. However, in this case, the relay terminal should not be used, but establishment of a radio resource control (RRC) connection should be triggered to restore the radio resource control (RRC) connection with the network with coverage here. On the other hand, when the terminal leaves a network coverage range, in order to maintain the connection with the network, the base station will transfer the service of the terminal to the relay terminal. The base station will send a radio resource control (RRC) message to the terminal. The radio resource control (RRC) message is configured to instruct the terminal to transfer the service to a target relay terminal. However, when the channel quality between the terminal and the base station is reduced rapidly, the terminal may not be able to correctly receive the radio resource control (RRC) message sent by the base station, which will result in the inability to transfer the service to the relay terminal.

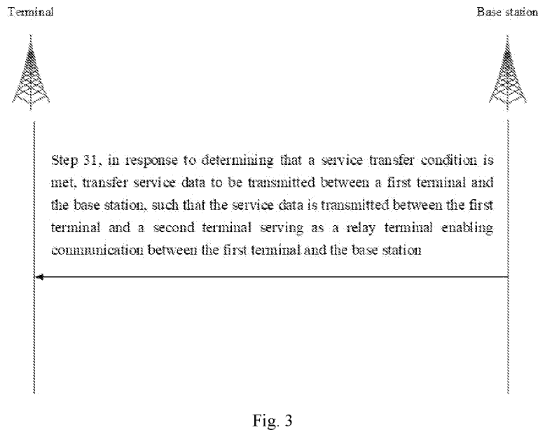

As shown in FIG. 3, the present example provides a method for transferring a service, performed by a first terminal, and including:

Step 31, in response to determining that a service switch condition is met, service data to be transmitted between the first terminal and a base station is transferred, such that the service data is transmitted between the first terminal and a second terminal, the second terminal is operating as a relay terminal enabling communication between the first terminal and the base station.

In one example, the service switch condition is sent by the base station;

or,

the service switch condition is specified by a communication protocol.

In one example, the first terminal receives the service switch condition sent by the base station.

In another example, the service switch condition is determined based on the communication protocol during wireless communication of the first terminal.

In one example, triggering the transferring the service data to be transmitted between the first terminal and the base station, such that the service data is transmitted between the first terminal and the second terminal includes:

triggering, by itself, the transferring the service data to be transmitted between the first terminal and the base station, such that the service data is transmitted between the first terminal and the second terminal.

In one example, the terminal may be, but is not limited to, a mobile phone, a wearable device, a vehicle-mounted terminal, a road side unit (RSU), a smart home terminal, an industrial sensing device and/or a medical device, and the like.

In one example, the base station is an interface device for the terminal to access a network. The base station may be various types of base stations, such as a 3G base station, a 4G base station, a 5G base station or other evolved base stations.

In one example, each base station corresponds to one serving cell. The base station may provide a wireless access service to the first terminal and the second terminal located in the serving cell. In one example, the base station may be an anchor base station of the first terminal.

In one example, the first terminal wirelessly communicates with the second terminal based on a sidelink.

In one example, a relay terminal may be a terminal with a relay function.

In one example, the second terminal may be the relay terminal.

In one example, the first terminal can learn the second terminal existing in the serving cell.

In one example, the base station may send identification information of all the second terminals or part of the second terminals in the serving cell to the first terminal in advance. The first terminal may select the second terminal according to identification of the second terminal and communicate with the selected second terminal. In one example, the first terminal selects the second terminal based on a wireless signal intensity between the first terminal and the second terminal.

In one example, in response to determining that the wireless signal intensity between the first terminal and the base station is greater than a wireless signal intensity threshold, the first terminal wirelessly communicates with the base station by establishing a radio resource control (RRC) connection.

In one example, the second terminal communicates with the base station based on a protocol of a wireless network radio (e.g., a Uu interface). The second terminal communicates with the first terminal based on a protocol of the sidelink.

In one example, the service transfer may be to transfer data transmitted between the first terminal and the base station based on the protocol of the wireless network radio (e.g., the Uu interface), such that the data is transmitted between the first terminal and the second terminal based on the protocol of the sidelink.

In one example, the second terminal may send the service data received from the first terminal to the base station through the protocol of the wireless network radio (e.g., the Uu interface). The second terminal may also send the service data received from the base station to the first terminal through the protocol of the sidelink.

In one example, the service switch condition sent by the base station based on a radio resource control (RRC) signaling may be received.

In one example, in response to the first terminal accessing the wireless network through the base station, the service switch condition sent by the base station is received.

In one example, the radio resource control (RRC) signaling may include a radio resource control (RRC) ConnectionReconfiguration signaling carrying the service switch condition. The terminal receives information of the service switch condition sent through the radio resource control (RRC) ConnectionReconfiguration signaling. In this way, the existing radio resource control (RRC) signaling may be utilized to carry the information of the service switch condition, thus realizing multiplexing of the radio resource control (RRC) signaling, and improving compatibility of the signaling.

In one example, the first terminal may receive the service switch condition sent by the base station before it is determined that the service switch condition is met.

In one example, please refer to FIG. 2 again, it may be to trigger a procedure of the service transfer in response to determining that the first terminal leaves the serving cell and the wireless signal intensity between the base station and the first terminal is always less than a time threshold within a predetermined time period.

In one example, it may be to trigger the procedure of the service transfer in response to determining that the first terminal enters a signal coverage blind area in the serving cell and the wireless signal intensity between the base station and the first terminal is always less than the time threshold within the predetermined time period.

In one example, it may be configured that a time length corresponding to the predetermined time period is less than a first time threshold in response to determining that the first terminal is a device (such as a mobile phone) that requires high real-time performance; and it may be configured that the time length corresponding to the predetermined time period is less than a second time threshold in response to determining that the first terminal is a device (such as a positioning device) that requires low real-time performance. Here, the first time threshold is less than the second time threshold. Here, the smaller the first time threshold is, the more quickly the first terminal can trigger the procedure of the service transfer. In the present example, different real-time requirements of different devices may be met.

In one example, when the first terminal needs to transfer the service data to be transmitted between the first terminal and the base station, such that the service data is transmitted between the first terminal and the second terminal, a signal intensity between the first terminal and the relay terminal existing in the serving cell may be tested, and a terminal whose wireless signal intensity is greater than the wireless signal intensity threshold is selected from the plurality of relay terminals to serve as the second terminal. Here, selecting the terminal whose wireless signal intensity is greater than the wireless signal intensity threshold to serve as the second terminal can make wireless communication quality between the first terminal and the second terminal higher.

In one example, the service switch condition may be that the wireless signal intensity for communication between the first terminal and the second terminal is greater than the set signal intensity threshold.

In one example, the procedure of the service transfer is triggered in response to determining that the first terminal leaves the serving cell and the wireless signal intensity between the base station and the first terminal is always less than the time threshold within the predetermined time period. After the procedure of the service transfer is started, when the signal intensity between the first terminal and the second terminal is greater than the set signal intensity threshold, the service data to be transmitted between the first terminal and the base station is transferred, such that the service data is transmitted between the first terminal and the second terminal.

In the example of the disclosure, the first terminal may receive the service switch condition sent by the base station before it is determined that the service switch condition is met. In response to determining that the service switch condition is met, the transferring the service data to be transmitted between the first terminal and the base station, such that the service data is transmitted between the first terminal and the second terminal, may be directly triggered. Compared with a mode that when the service needs to be transferred, the first terminal obtains the second terminal indicated by the base station from the base station through the radio resource control (RRC) message, and transfer the service data to be transmitted between the first terminal and the base station, such that the service data is transmitted between the first terminal and the second terminal, a situation that service transfer cannot be realized due to the failure to receive the radio resource control (RRC) message is reduced, reliability of the service transfer is improved, and stability of the communication network is improved.

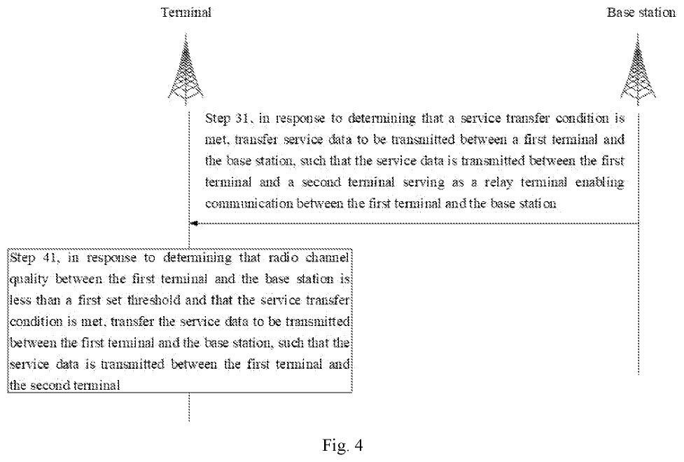

As shown in FIG. 4, the present example provides a method for transferring a service, further including:

Step 41, in response to determining that radio channel quality between a first terminal and a base station is lower than a first set threshold and that a service switch condition is met, service data to be transmitted between the first terminal and the base station is transferred, such that the service data is transmitted between the first terminal and a second terminal.

In one example, determining that the radio channel quality between the first terminal and the base station is lower than the first set threshold may be either determining that the radio channel quality between the first terminal and the base station is lower than the first set threshold within one or more predetermined time periods, or determining that the radio channel quality between the first terminal and the base station is lower than the first set threshold at one or more predetermined time points.

In one example, the predetermined time period or time point is configured by the base station, and the base station sends information of the configured time period or time point to the first terminal.

In one example, the base station may configure that a time length corresponding to the predetermined time period or the number of the predetermined time period is less than a first threshold in response to determining that the first terminal is a device (such as a mobile phone) that requires both high reliability and real-time performance; and the base station may configure that the time length corresponding to the predetermined time period or the number of the predetermined time period is less than a second threshold in response to determining that the first terminal is a device (such as a positioning device) that requires both low reliability and real-time performance. Here, the first threshold is less than the second threshold.

In one example, the first set threshold is configured by the base station, and the base station sends information of the configured first set threshold to the first terminal.

In one example, the base station may configure the first set threshold as a value A in response to determining that the first terminal is the device (such as the mobile phone) that requires high reliability; and the base station may configure the first set threshold as a value B in response to determining that the first terminal is the device (such as the positioning device) that requires low reliability. Here, the value A is greater than the value B.

In one example, radio channel quality data between the first terminal and the base station within the predetermined time period may be sampled for statistics, and then the radio channel quality data sampled for statistics may be averaged. When an average value is lower than the first set threshold, it may be determined that the radio channel quality between the first terminal and the base station is lower than the first set threshold within the predetermined time period.

In one example, when the signal intensity between the first terminal and the second terminal is greater than the set signal intensity threshold, the first terminal determines that the service switch condition is met.

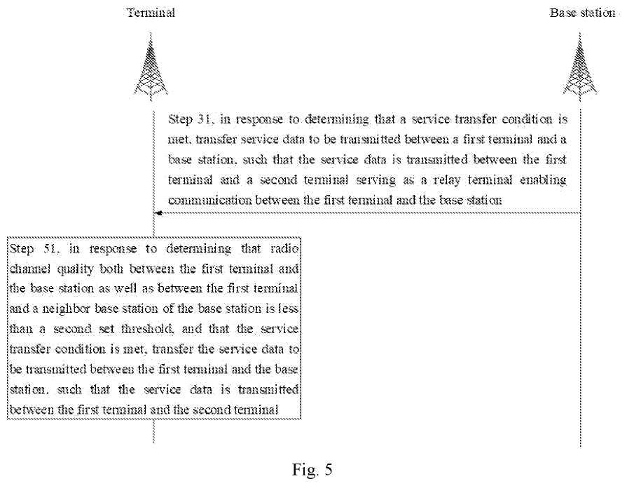

As shown in FIG. 5, the present example provides a method for transferring a service, further including:

Step 51, in response to determining that radio channel quality both between a first terminal and a base station as well as between the first terminal and a neighbor base station of the base station is lower than a second set threshold, and that a service switch condition is met, service data to be transmitted between the first terminal and the base station is transferred, such that the service data is transmitted between the first terminal and a second terminal.

In one example, determining that the radio channel quality between the first terminal and the base station as well as between the first terminal and the neighbor base station of the base station is lower than the second set threshold may be either determining that the radio channel quality between the first terminal and the base station as well as between the first terminal and the neighbor base station of the base station is lower than the second set threshold within one or more predetermined time periods, or determining that the radio channel quality between the first terminal and the base station as well as between the first terminal and the neighbor base station of the base station is lower than the second set threshold at one or more predetermined time points.

In one example, the predetermined time period or time point is configured by the base station, and the base station sends information of the configured time period or time point to the first terminal.

In one example, the base station may configure that a time length corresponding to the predetermined time period or the number of the predetermined time period is less than a first threshold in response to determining that the first terminal is a device (such as a mobile phone) that requires both high reliability and real-time performance; and the base station may configure that the time length corresponding to the predetermined time period or the number of the predetermined time period is less than a second threshold in response to determining that the first terminal is a device (such as a positioning device) that requires both low reliability and real-time performance. Here, the first threshold is less than the second threshold.

In one example, each base station corresponds to one serving cell, the neighbor base station is an adjacent base station of the base station, and neighbor base station corresponds to one cell of the neighbor base station.

In one example, a connection interface between the base station and the neighbor base station may be an X2 interface of 4G; and a connection interface between the base station and the neighbor base station may also be an Xn interface of 5G.

In one example, the second set threshold is configured by the base station, and the base station sends information of the configured second set threshold to the first terminal. Here, the first set threshold may be the same as the second set threshold, and the first set threshold may also be different from the second set threshold.

In one example, the base station may configure the second set threshold as a value C in response to determining that the first terminal is the device (such as the mobile phone) that requires high reliability; and the base station may configure the second set threshold as a value D in response to determining that the first terminal is the device (such as the positioning device) that requires low reliability. Here, the value C is greater than the value D.

In one example, radio channel quality data between the first terminal and the base station within the predetermined time period may be sampled for statistics, and then the radio channel quality data sampled for statistics may be averaged. When an average value is lower than the second set threshold, it may be determined that the radio channel quality between the first terminal and the base station is lower than the second set threshold within the predetermined time period.

In one example, the service switch condition at least includes that:

channel quality between the first terminal and the second terminal is higher than a third set threshold within a predetermined time period.

In one example, the third set threshold is configured by the base station, and the base station sends information of the configured third set threshold to the first terminal.

In one example, it may be that a signal intensity of a wireless communication signal between the first terminal and the second terminal is greater than the third set threshold within the predetermined time period.

In one example, the base station may configure the third set threshold as a value E in response to determining that the first terminal is the device (such as the mobile phone) that requires high reliability; and the base station may configure the third set threshold as a value F in response to determining that the first terminal is the device (such as the positioning device) that requires low reliability. Here, the value E is greater than the value F.

In one example, radio channel quality data between the first terminal and the second terminal within the predetermined time period may be sampled for statistics, and then the radio channel quality data sampled for statistics may be averaged. When an average value is higher than the third set threshold, it may be determined that the radio channel quality between the first terminal and the second terminal is higher than the third set threshold within the predetermined time period.

In one example, the service switch condition further includes that:

a distance between the first terminal and the base station is greater than a distance threshold;

and/or,

the first terminal is not able to search for a cell whose signal intensity is greater than a signal intensity threshold.

In one example, in response to determining that the radio channel quality between the first terminal and the base station is lower than the first set threshold within the predetermined time period, the channel quality between the first terminal and the second terminal is higher than the third set threshold within the predetermined time period, and the distance between the first terminal and the base station is greater than the distance threshold, it is determined that the first terminal needs to transfer the service.

In one example, in response to determining that the radio channel quality between the first terminal and the base station is lower than the first set threshold within the predetermined time period, the channel quality between the first terminal and the second terminal is higher than the third set threshold within the predetermined time period, and the first terminal is not able to search for the cell whose signal intensity is greater than the signal intensity threshold, it is determined that the first terminal needs to transfer the service.

In one example, the distance between the first terminal and the base station is sampled within the predetermined time period. In response to determining that the average value of a sampling value of the distance between the first terminal and the base station is greater than the distance threshold, it is determined that the distance between the first terminal and the base station is greater than the distance threshold.

In one example, a situation that the first terminal is not able to search for the cell whose signal intensity is greater than the signal intensity threshold may be unable to search for a suitable cell other than a serving cell, where the suitable cell is a cell whose signal intensity is greater than the signal intensity threshold.

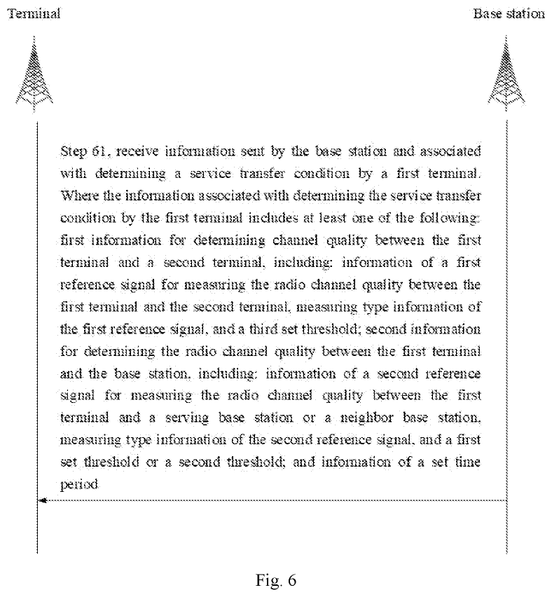

As shown in FIG. 6, the present example provides a method for transferring a service, further including:

Step 61, information sent by a base station and associated with determining a service switch condition by a first terminal is received.

The information associated with determining the service switch condition by the first terminal includes at least one of the following:

first information for determining channel quality between the first terminal and a second terminal, including: information of a first reference signal for measuring the radio channel quality between the first terminal and the second terminal, measuring type information of the first reference signal, and a third set threshold;

second information for determining radio channel quality between the first terminal and a base station, including: information of a second reference signal for measuring the radio channel quality between the first terminal and the serving base station or a neighbor base station, measuring type information of the second reference signal, and a first set threshold or a second set threshold; and

information of a predetermined time period, where the information of the predetermined time period is configured to determine that the radio channel quality between the first terminal and the base station is lower than the first set threshold within the predetermined time period, or configured to determine that radio channel quality both between the first terminal and the base station as well as between the first terminal and a neighbor base station of the base station is lower than the second set threshold within the predetermined time period, or configured to determine that the channel quality between the first terminal and the second terminal is higher than the third set threshold within the predetermined time period.

In one example, the first reference signal is one of the following: a synchronization signal and PBCH block (SSB) reference signal and a channel-state information reference signal (CSI-RS).

In one example, the second reference signal is one of the following: a demodulation reference signal (DMRS) and a channel-state information reference signal (CSI-RS).

In one example, the measuring type includes one of the following: reference signal receiving power (RSRP), reference signal receiving quality (RSRQ) and a channel quality indicator (CQI).

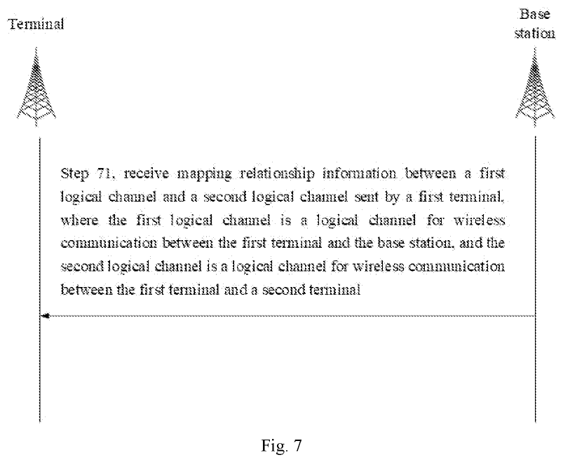

As shown in FIG. 7, the present example provides a method for transferring a service, further including:

Step 71, mapping relationship information between a first logical channel and a second logical channel sent by a base station is received; where

the first logical channel is a logical channel for wireless communication between a first terminal and a base station, and the second logical channel is a logical channel for wireless communication between the first terminal and a second terminal.

In one example, the first logical channel is a logical channel of cellular wireless communication, and the second logical channel is a logical channel of sidelink wireless communication.

In one example, the logical channel may be a control channel or a service channel. The control channel is configured to transmit control plane information, and the service channel is configured to transmit user plane information.

In one example, the control channel is configured to transmit a signaling or synchronization data, and the service channel transmits encoded and encrypted data.

In one example, the first logical channel is a logical channel corresponding to wireless communication of a wireless network radio (e.g., a Uu interface). The second logical channel is a logical channel corresponding to wireless communication of a PC-5 interface of the sidelink.

In order to facilitate understanding of any example of the disclosure, the technical solution of the disclosure is further illustrated by examples through one example.

### Example 1

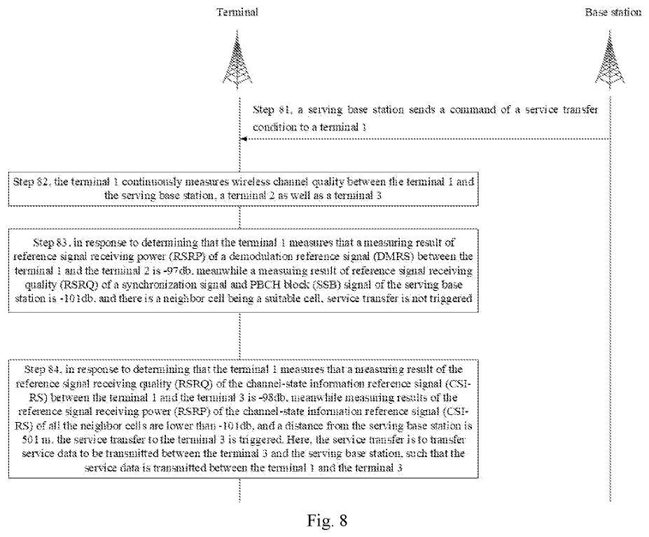

The wireless communication system includes a serving base station, a terminal 1, a terminal 2 and a terminal 3. The terminals 2 and 3 have a relay function. Please refer to FIG. 8, and the method includes:

step 81, the serving base station sends a command of a service switch condition to the terminal 1. The service switch condition is configured to trigger the terminal 1 to transfer, in response to determining that the service switch condition is met, the service data to be transmitted between the terminal 1 and the serving base station, such that the service data is transmitted between the terminal 1 and the terminal 2. The command of the service switch condition at least carries the following information:

identification B of the terminal 2; information that the type of a sidelink reference signal corresponding to the terminal 2 is the demodulation reference signal (DMRS); information that the measuring type of the sidelink is the reference signal receiving power (RSRP); information that the third set threshold is −98 db; information that a Uu interface reference signal is synchronization signal and PBCH block (SSB); information that the measuring type of the Uu interface is the reference signal receiving quality (RSRQ); information that the second set threshold is −100 db; information indicating that no suitable cell can be searched except the serving cell; and information that Uu interface measuring configuration is suitable for the serving cell. Identification C of the terminal 3; information that the type of a sidelink reference signal corresponding to the terminal 3 is the channel-state information reference signal (CSI-RS); information that the measuring type of the sidelink is the reference signal receiving quality (RSRQ); information that the third set threshold is −99 db; information that the Uu interface reference signal is the channel-state information reference signal (CSI-RS); information that the measuring type of the Uu interface is the reference signal receiving power (RSRP); information that the second set threshold is −101 db; information that the set distance is 500 m; and information that the Uu interface measuring configuration is suitable for all the cells.

Step 82, the terminal 1 continuously measures the wireless channel quality between the terminal 1 and the serving base station, the terminal 2 as well as the terminal 3.

Step 83, in response to determining that the terminal 1 measures that a measuring result of the reference signal receiving power (RSRP) of the demodulation reference signal (DMRS) between the terminal 1 and the terminal 2 is −97 db, meanwhile a measuring result of the reference signal receiving quality (RSRQ) of the synchronization signal and PBCH block (SSB) signal of the serving base station is −101 db, and there is the neighbor cell being the suitable cell, service transfer is not triggered.

Step 84, in response to determining that the terminal 1 measures that a measuring result of the reference signal receiving quality (RSRQ) of the channel-state information reference signal (CSI-RS) between the terminal 1 and the terminal 3 is −98 db, meanwhile measuring results of the reference signal receiving power (RSRP) of the channel-state information reference signal (CSI-RS) of all the neighbor cells are lower than −101 db, and the distance from the serving base station is 501 m, the service transfer to the terminal 3 is triggered. Here, the service transfer is to transfer the service data to be transmitted between the terminal 1 and the serving base station, such that the service data is transmitted between the terminal 1 and the terminal 3.

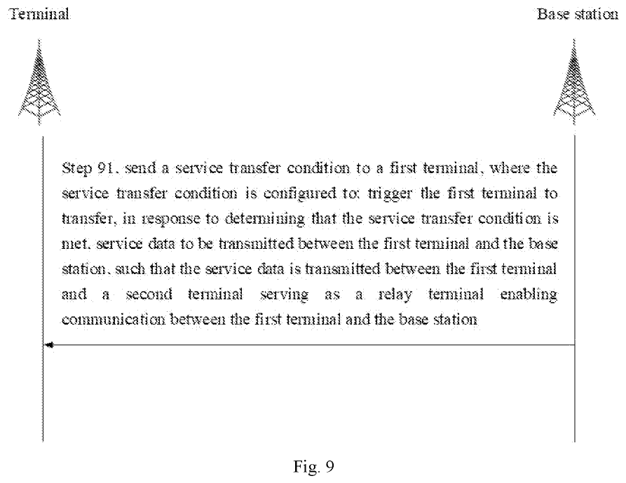

As shown in FIG. 9, the present example provides a method for transferring a service, performed by a base station and including:

step 91, a service switch condition is sent to a first terminal, where

the service switch condition is configured to: trigger the first terminal to transfer, in response to determining that the service switch condition is met, service data to be transmitted between the first terminal and a base station, such that the service data is transmitted between the first terminal and a second terminal, the second terminal is operating as a relay terminal enabling communication between the first terminal and the base station.

In one example, triggering the first terminal to transfer, in response to determining that the service switch condition is met, the service data to be transmitted between the first terminal and the base station, such that the service data is transmitted between the first terminal and the second terminal includes:

The first terminal is triggered, in response to determining that the service switch condition is met, to transfer, by itself, the service data to be transmitted between the first terminal and the base station, such that the service data is transmitted between the first terminal and the second terminal.

In one example, the terminal may be, but is not limited to, a mobile phone, a wearable device, a vehicle-mounted terminal, a road side unit (RSU), a smart home terminal, an industrial sensing device and/or a medical device, and the like.

In one example, the base station is an interface device for the terminal to access a network. The base station may be various types of base stations, such as a 3G base station, a 4G base station, a 5G base station or other evolved base stations.

In one example, each base station corresponds to one serving cell, and the base station may provide a wireless access service to the first terminal, the second terminal or a relay terminal located in the serving cell.

In one example, the first terminal wirelessly communicates with the second terminal based on a sidelink.

In one example, the relay terminal may be a terminal with a relay function.

In one example, the second terminal may be the relay terminal.

In one example, the first terminal can learn the second terminal existing in the serving cell.

In one example, the base station may send identification information of all or part of the second terminals in the serving cell to the first terminal in advance. In this way, the first terminal may select the second terminal according to identification of the second terminal and communicate with the selected second terminal. In one example, the first terminal selects the second terminal based on a wireless signal intensity between the first terminal and the second terminal.

In one example, in response to determining that the wireless signal intensity between the first terminal and the base station is greater than a wireless signal intensity threshold, the first terminal communicates with the base station by establishing a radio resource control (RRC) connection.

In one example, the second terminal communicates with the base station based on a protocol of a wireless network radio (e.g., a Uu interface). The second terminal communicates with the first terminal based on a protocol of the sidelink.

In one example, the service transfer may be to transfer data transmitted between the first terminal and the base station based on the protocol of the Uu interface, such that the data is transmitted between the first terminal and the second terminal based on the protocol of the sidelink.

In one example, the second terminal may send the service data received from the first terminal to the base station through the protocol of the wireless network radio (e.g., the Uu interface). The second terminal may also send the service data received from the base station to the first terminal through the protocol of the sidelink.

In one example, the service switch condition sent by the base station based on a radio resource control (RRC) signaling may be received.

In one example, in response to the first terminal accessing the wireless network through the base station, the service switch condition sent by the base station is received.

In one example, the radio resource control (RRC) signaling may include a radio resource control (RRC) ConnectionReconfiguration signaling carrying the service switch condition. The base station sends information of the service switch condition through the radio resource control (RRC) ConnectionReconfiguration signaling. In this way, the existing radio resource control (RRC) signaling may be utilized to carry the information of the service switch condition, thus realizing multiplexing of the radio resource control (RRC) signaling and improving compatibility of the signaling.

In one example, the base station may send the service switch condition to the first terminal before it is determined that the service switch condition is met.

In one example, please refer to FIG. 2 again, it may be to trigger a procedure of the service transfer in response to determining that the first terminal leaves the serving cell and the wireless signal intensity between the base station and the first terminal is always less than a time threshold within a predetermined time period.

In one example, it may be to trigger the procedure of the service transfer in response to determining that the first terminal enters a signal coverage blind area in the serving cell and the wireless signal intensity between the base station and the first terminal is always less than the time threshold within the predetermined time period.

In one example, it may be configured that a time length corresponding to the predetermined time period is less than a first time threshold in response to determining that the first terminal is a device (such as a mobile phone) that requires high reliability and real-time performance; and it may be configured that the time length corresponding to the predetermined time period is less than a second time threshold in response to determining that the first terminal is a device (such as a positioning device) that requires low reliability and real-time performance. Here, the first time threshold is less than the second time threshold.

In one example, when the first terminal needs to transfer the service data to be transmitted between the first terminal and the base station, such that the service data is transmitted between the first terminal and the second terminal, a signal intensity between the first terminal and the relay terminal existing in the serving cell may be tested, and a terminal whose wireless signal intensity is greater than the wireless signal intensity threshold is selected from the plurality of relay terminals to serve as the second terminal.

In one example, the service switch condition may be that the wireless signal intensity for communication between the first terminal and the second terminal is greater than the set signal intensity threshold.

In one example, the procedure of the service transfer is triggered in response to determining that the first terminal leaves the serving cell and the wireless signal intensity between the base station and the first terminal is always less than the time threshold within the predetermined time period. After the procedure of the service transfer is started, when the signal intensity between the first terminal and the second terminal is greater than the set signal intensity threshold, the service data to be transmitted between the first terminal and the base station is transferred, such that the service data is transmitted between the first terminal and the second terminal.

In one example, the service switch condition at least includes that:

channel quality between the first terminal and the second terminal is higher than a third set threshold within a predetermined time period.

In one example, the third set threshold is configured by the base station, and the base station sends information of the configured third set threshold to the first terminal.

In one example, it may be that a signal intensity of a wireless communication signal between the first terminal and the second terminal is greater than the third set threshold within the predetermined time period.

In one example, the base station may configure the third set threshold as a value E in response to determining that the first terminal is the device (such as the mobile phone) that requires high reliability; and the base station may configure the third set threshold as a value F in response to determining that the first terminal is the device (such as the positioning device) that requires low reliability. Here, the value E is greater than the value F.

In one example, the service switch condition further includes that:

a distance between the first terminal and the base station is greater than a distance threshold;

and/or,

the first terminal is not able to search for a cell whose signal intensity is greater than a signal intensity threshold.

In one example, in response to determining that the distance between the first terminal and the base station is greater than the distance threshold, it is determined that the first terminal needs to transfer the service.

In one example, the distance between the first terminal and the base station is greater than the distance threshold within the predetermined time period.

In one example, the distance between the first terminal and the base station is sampled within the predetermined time period. In response to determining that the average value of a sampling value of the distance between the first terminal and the base station is greater than the distance threshold, it is determined that the distance between the first terminal and the base station is greater than the distance threshold.

In one example, a situation that the first terminal is not able to search for the cell whose signal intensity is greater than the signal intensity threshold may be unable to search for a suitable cell other than a serving cell, where the suitable cell is a cell whose signal intensity is greater than the signal intensity threshold.

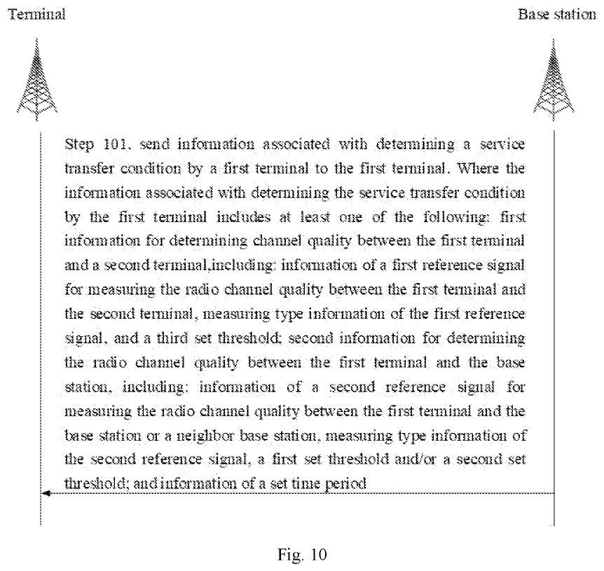

As shown in FIG. 10, the present example provides a method for transferring a service, further including:

step 101, information associated with determining a service switch condition by a first terminal is sent to the first terminal. The information associated with determining the service switch condition by the first terminal includes at least one of the following:

first information for determining channel quality between the first terminal and a second terminal, including: information of a first reference signal for measuring the radio channel quality between the first terminal and the second terminal, measuring type information of the first reference signal, and a third set threshold;

second information for determining radio channel quality between the first terminal and a base station, including: information of a second reference signal for measuring the radio channel quality between the first terminal and the base station or a neighbor base station, measuring type information of the second reference signal, a first set threshold and/or a second set threshold; and

information of a predetermined time period, where the information of the predetermined time period is configured to determine that the radio channel quality between the first terminal and the base station is lower than the first set threshold within the predetermined time period, or configured to determine that radio channel quality both between the first terminal and the base station as well as between the first terminal and a neighbor base station of the base station is lower than the second set threshold within the predetermined time period, or configured to determine that the channel quality between the first terminal and the second terminal is higher than the third set threshold within the predetermined time period.

In one example, the first reference signal is one of the following: a synchronization signal and PBCH block (SSB) reference signal and a channel-state information reference signal (CSI-RS).

In one example, the second reference signal is one of the following: a demodulation reference signal (DMRS) and a channel-state information reference signal (CSI-RS).

In one example, the measuring type includes one of the following: reference signal receiving power (RSRP), reference signal receiving quality (RSRQ) and a channel quality indicator (CQI).

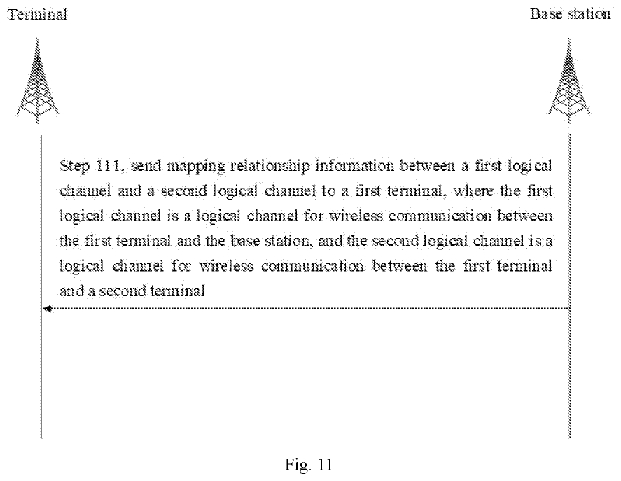

As shown in FIG. 11, the present example provides a method for transferring a service, further including:

Step 111, mapping relationship information between a first logical channel and a second logical channel is sent to a first terminal, where the first logical channel is a logical channel for wireless communication between the first terminal and a base station, and the second logical channel is a logical channel for wireless communication between the first terminal and a second terminal.

In one example, the logical channel may be a control channel or a service channel. The control channel is configured to transmit control plane information, and the service channel is configured to transmit user plane information.

In one example, the first logical channel is a logical channel of cellular wireless communication, and the second logical channel is a logical channel of sidelink wireless communication.

In one example, the control channel is configured to transmit a signaling or synchronization data, and the service channel transmits encoded and encrypted data.

In one example, the first logical channel is a logical channel corresponding to wireless communication of a wireless network radio (e.g., a Uu interface). The second logical channel is a logical channel corresponding to wireless communication of a PC-5 interface of the sidelink.

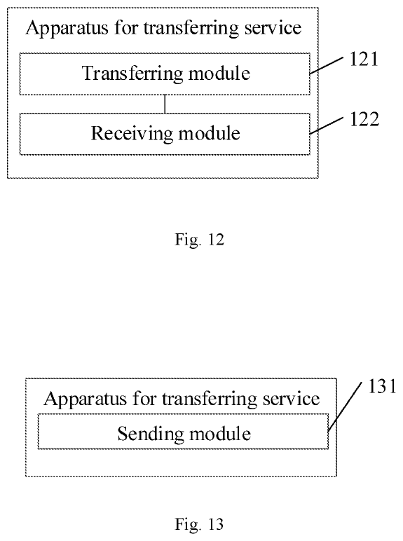

As shown in FIG. 12, the present example provides an apparatus for transferring a service, performed by a first terminal, and including a transferring module 121, where the transferring module 121 is configured to transfer, in response to determining that a service switch condition is met, service data to be transmitted between the first terminal and a base station, such that the service data is transmitted between the first terminal and a second terminal, the second terminal is operating as a relay terminal enabling communication between the first terminal and the base station.

In one example, the apparatus further includes a receiving module 122, where the receiving module 122 is configured that the service switch condition is sent by the base station; or, the service switch condition is specified by a communication protocol.

In on example, the transferring module 121 is further configured to: transfer, in response to determining that radio channel quality between the first terminal and the base station is lower than a first set threshold and that the service switch condition is met, the service data to be transmitted between the first terminal and the base station, such that the service data is transmitted between the first terminal and the second terminal.

In one example, the transferring module 121 is further configured to: transfer, in response to determining that radio channel quality both between the first terminal and the base station as well as between the first terminal and a neighbor base station of the base station is lower than a second set threshold and that the service switch condition is met, the service data to be transmitted between the first terminal and the base station, such that the service data is transmitted between the first terminal and the second terminal.

As shown in FIG. 13, the present example provides an apparatus for transferring a service, performed by a base station, and including a sending module 131, where

the sending module 131 is configured to send a service switch condition to a first terminal, where

the service switch condition is configured to: trigger the first terminal to transfer, in response to determining that the service switch condition is met, service data to be transmitted between the first terminal and a base station, such that the service data is transmitted between the first terminal and a second terminal, the second terminal is operating as a relay terminal enabling communication between the first terminal and the base station.

As for the apparatus in the above examples, the specific modes for executing operations by all the modules have be described in the examples related to the method in detail, which is not illustrated in detail here.

An example of the disclosure provides a communication device, including:

a processor; and

a memory for storing executable instructions of the processor; where

the processor is configured to: implement the method described in any example of the disclosure when running the executable instructions.

The processor may include various types of storage media, which are non-transitory computer storage media that can continue to memorize information stored on it after the communication device is powered down.

The processor may be connected with the memory through a bus or the like, for reading an executable program stored on the memory.

The example of the disclosure further provides a non-transitory computer storage medium. The non-transitory computer storage medium stores a computer executable program. The executable program, when executed by a processor, implements the method according to any example of the disclosure.

As for the apparatus in the above examples, the specific modes for executing operations by all the modules have be described in the examples related to the method in detail, which is not illustrated in detail here.

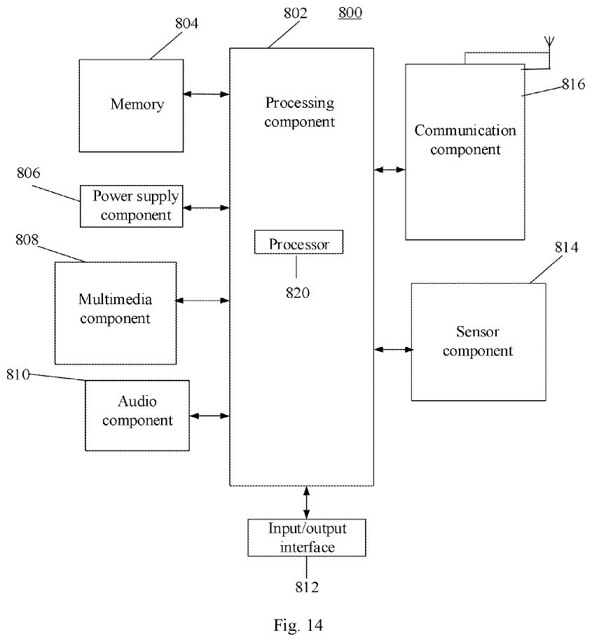

FIG. 14 is a block diagram of user equipment (UE) 800 shown according to an example. For example, the user equipment 800 may be a mobile telephone, a computer, digital broadcast user equipment, a message transceiving device, a game console, a tablet device, a medical device, a fitness device, a personal digital assistant, and the like.

Referring to FIG. 14, the user equipment 800 may include one or more of the following components: a processing component 802, a memory 804, a power supply component 806, a multimedia component 808, an audio component 810, an input/output (I/O) interface 812, a sensor component 814, and a communication component 816.

The processing component 802 usually controls overall operation of the user equipment 800, such as operations associated with displaying, telephone calling, data communication, a camera operation and a record operation. The processing component 802 may include one or more processors 820 to execute an instruction, so as to complete all or part of steps of the above method. In addition, the processing component 802 may include one or more modules, so as to facilitate interaction between the processing component 802 and other components. For example, the processing component 802 may include a multimedia module, so as to facilitate interaction between the multimedia component 808 and the processing component 802.

The memory 804 is configured to store various types of data so as to support operations on the user equipment 800. Examples of these data include instructions of any application programs or methods used to be operated on the user equipment 800, contact data, telephone directory data, messages, pictures, videos, and the like. The memory 804 may be implemented by any type of volatile or nonvolatile storage device or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 806 provides electric power for various components of the user equipment 800. The power supply component 806 may include a power management system, one or more power sources, and other components associated with generating, managing and distributing electric power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors to sense touching, swiping and gestures on the touch panel. The touch sensor may not only sense a boundary of a touching or swiping action, but also detect duration and pressure related to the touching or swiping operation. In some examples, the multimedia component 808 includes a front camera and/or a back camera. When the user equipment 800 is in an operation mode, such as a shooting mode or a video mode, the front camera and/or the back camera may receive external multimedia data. Each front camera and each back camera may be a fixed optical lens system or have a focal length and optical zooming capability.

The audio component 810 is configured to output and/or input an audio signal. For example, the audio component 810 includes a microphone (MIC). When the user equipment 800 is in the operation mode, such as a call mode, a recording mode or a speech recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the above peripheral interface module may be a keyboard, a click wheel, buttons, etc. These buttons may include but are not limited to: a home button, a volume button, a start button and a lock button.

The sensor component 814 includes one or more sensors for providing state evaluations of all aspects for the user equipment 800. For example, the sensor component 814 may detect an on/off state of the equipment 800 and relative positioning of components, for example, the components are a display and a keypad of the user equipment 800. The sensor component 814 may further detect position change of the user equipment 800 or one component of the user equipment 800, whether there is contact between the user and the user equipment 800, azimuth or speed up/speed down of the user equipment 800, and temperature change of the user equipment 800. The sensor component 814 may include a proximity sensor, which is configured to detect existence of a nearby object without any physical contact. The sensor component 814 may further include an optical sensor, such as a CMOS or CCD image sensor, for use in imaging application. In some examples, the sensor component 814 may further include an acceleration sensor, a gyroscope sensor, a magnetic sensor, a pressure sensor or a temperature sensor.

The communication component 816 is configured to facilitate wired or wireless communication between the user equipment 800 and other devices. The user equipment 800 may access into a wireless network based on a communication standard, such as WiFi, 2G or 3G, or their combination. In one example, the communication component 816 receives a broadcast signal or broadcast related information from an external broadcast management system via a broadcast channel. In one example, the communication component 816 further includes a near-field communication (NFC) module so as to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In the example, the user equipment 800 may be implemented by one or more application specific integrated circuits (ASICs), digital signal processors (DSPs), digital signal processing devices (DSPDs), programmable logic devices (PLDs), field-programmable gate arrays (FPGAs), controllers, microcontrollers, microprocessors or other electronic elements for executing the above method.

In the example, a non-transitory computer readable storage medium including instructions is further provided, such as a memory 804 including instructions. The above instructions may be executed by a processor 820 of the user equipment 800 so as to complete the above method. For example, the non-transitory computer readable storage medium may be an ROM, a random access memory (RAM), a CD-ROM, a magnetic tape, a floppy disk, an optical data storage device and the like.

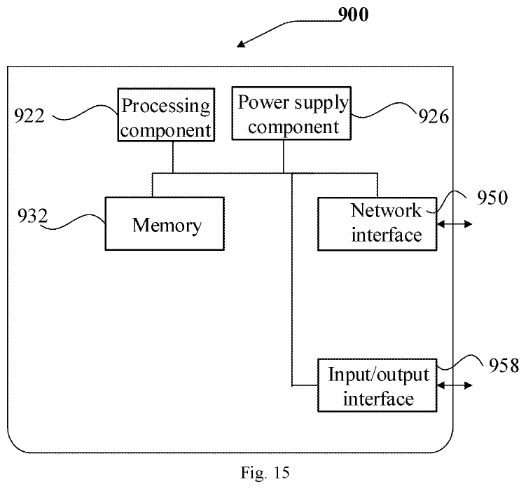

As shown in FIG. 15, an example of the disclosure shows a structure of a base station. For example, the base station 900 may be provided as a network-side device. Referring to FIG. 15, the base station 900 includes a processing component 922, which further includes one or more processors, and a memory resource represented by a memory 932, for storing instructions executable by the processing component 922, such as an application program. The application program stored in the memory 932 may include one or more modules with each corresponding to a set of instructions. In addition, the processing component 922 is configured to execute the instructions so as to execute any of the aforementioned methods performed by the base station, for example, the methods shown in FIG. 2-FIG. 6.

The base station 900 may further include a power supply component 926 configured to execute power supply management of the base station 900, a wired or wireless network interface 950 configured to connect the base station 900 to a network, and an input/output (I/O) interface 958. The base station 900 may operate based on an operating system stored in a memory 932, such as Windows Server™, Mac OS X™, Unix™, Linux™, FreeBSD™ or the like.

Those of skill in the art will easily figure out other implementation solutions of the disclosure after considering the specification and practicing the invention disclosed here. The disclosure intends to cover any transformation, usage or adaptive change of the disclosure, and these transformations, usages or adaptive changes conform to a general principle of the disclosure and include common general knowledge or conventional technical means which are not disclosed herein in the technical field. The specification and the examples are merely regarded as an example, and the true scope and spirit of the disclosure are indicated by the following claims.

It will be appreciated that the disclosure is not limited to the exact construction that has been described above and shown in the accompanying drawings, and that various modifications and changes may be made without departing from its scope. It is intended that the scope of the disclosure merely be limited by the appended claims.

According to a first aspect of the disclosure, a method for transferring a service is provided, performed by a first terminal, and including:

in response to determining that a service switch condition is met, transferring service data to be transmitted between the first terminal and a base station, such that the service data is transmitted between the first terminal and a second terminal, the second terminal is operating as a relay terminal enabling communication between the first terminal and the base station.

In one example, the service switch condition is sent by the base station;

or,

the service switch condition is specified by a communication protocol.

In one example, the method further includes:

in response to determining that radio channel quality between the first terminal and the base station is lower than a first set threshold, and that the service switch condition is met, transferring the service data to be transmitted between the first terminal and the base station, such that the service data is transmitted between the first terminal and the second terminal.

In one example, the method further includes:

in response to determining that radio channel quality both between the first terminal and the base station as well as between the first terminal and a neighbor base station of the base station is lower than a second set threshold, and that the service switch condition is met, transferring the service data to be transmitted between the first terminal and the base station, such that the service data is transmitted between the first terminal and the second terminal.

In one example, the service switch condition at least includes that:

channel quality between the first terminal and the second terminal is higher than a third set threshold within a predetermined time period.

In one example, the service switch condition further includes that:

a distance between the first terminal and the base station is greater than a distance threshold;

and/or,

the first terminal is not able to search for a cell whose signal intensity is greater than a signal intensity threshold.

In one example, the method further includes:

receiving information sent by the base station and associated with determining the service switch condition by the first terminal; where

the information associated with determining the service switch condition by the first terminal includes at least one of the following:

first information for determining the channel quality between the first terminal and the second terminal, including: information of a first reference signal for measuring the radio channel quality between the first terminal and the second terminal, measuring type information of the first reference signal, and the third set threshold;

second information for determining the radio channel quality between the first terminal and the base station, including: information of a second reference signal for measuring the radio channel quality between the first terminal and the base station or the neighbor base station, measuring type information of the second reference signal, the first set threshold and/or the second set threshold; and

information of the predetermined time period, where the information of the predetermined time period is configured to determine that the radio channel quality between the first terminal and the base station is lower than the first set threshold within the predetermined time period, or configured to determine that radio channel quality both between the first terminal and the base station as well as between the first terminal and the neighbor base station of the base station is lower than the second set threshold within the predetermined time period, or configured to determine that the channel quality between the first terminal and the second terminal is higher than the third set threshold within the predetermined time period.

In one example, the first reference signal is one of the following: a synchronization signal and PBCH block (SSB) reference signal and a channel-state information reference signal (CSI-RS).

In one example, the second reference signal is one of the following: a demodulation reference signal (DMRS) and a channel-state information reference signal (CSI-RS).

In one example, the measuring type includes one of the following: reference signal receiving power (RSRP), reference signal receiving quality (RSRQ) and a channel quality indicator (CQI).

In one example, the method further includes:

receiving mapping relationship information between a first logical channel and a second logical channel sent by the base station; where

the first logical channel is a logical channel for wireless communication between the first terminal and the base station, and the second logical channel is a logical channel for wireless communication between the first terminal and the second terminal.

In one example, the first terminal communicates with the second terminal based on a sidelink.

According to a second aspect of the disclosure, a method for transferring a service is provided, performed by a base station, and including:

sending a service switch condition to a first terminal, where

the service switch condition is configured to: trigger the first terminal to transfer, in response to determining that the service switch condition is met, service data to be transmitted between the first terminal and the base station, such that the service data is transmitted between the first terminal and a second terminal, the second terminal is operating as a relay terminal enabling communication between the first terminal and the base station.

In one example, the service switch condition at least includes that:

channel quality between the first terminal and the second terminal is higher than a third set threshold within a predetermined time period.

In one example, the service switch condition further includes that:

a distance between the first terminal and the base station is greater than a distance threshold;

and/or,

the first terminal is not able to search for a cell whose signal intensity is greater than a signal intensity threshold.

In one example, the method further includes:

sending information associated with determining the service switch condition by the first terminal to the first terminal; where

the information associated with determining the service switch condition by the first terminal includes at least one of the following:

first information for determining the channel quality between the first terminal and the second terminal, including: information of a first reference signal for measuring the radio channel quality between the first terminal and the second terminal, measuring type information of the first reference signal, and the third set threshold;

second information for determining the radio channel quality between the first terminal and the base station, including: information of a second reference signal for measuring the radio channel quality between the first terminal and the base station or the neighbor base station, measuring type information of the second reference signal, a first set threshold and/or a second set threshold; and

information of the predetermined time period, where the information of the predetermined time period is configured to determine that the radio channel quality between the first terminal and the base station is lower than the first set threshold within the predetermined time period, or configured to determine that radio channel quality both between the first terminal and the base station as well as between the first terminal and the neighbor base station of the base station is lower than the second set threshold within the predetermined time period, or configured to determine that the channel quality between the first terminal and the second terminal is higher than the third set threshold within the predetermined time period.

In one example, the first reference signal is one of the following: a synchronization signal and PBCH block (SSB) reference signal and a channel-state information reference signal (CSI-RS).

In one example, the second reference signal is one of the following: a demodulation reference signal (DMRS) and a channel-state information reference signal (CSI-RS).

In one example, the measuring type includes one of the following: reference signal receiving power (RSRP), reference signal receiving quality (RSRQ) and a channel quality indicator (CQI).

In one example, the method further includes:

sending mapping relationship information between a first logical channel and a second logical channel to the first terminal, where the first logical channel is a logical channel for wireless communication between the first terminal and the base station, and the second logical channel is a logical channel for wireless communication between the first terminal and the second terminal.

In one example, the first terminal communicates with the second terminal based on a sidelink.

According to a third aspect of the disclosure, an apparatus for transferring a service is provided, performed by a first terminal, and including a transferring module, where

the transferring module is configured to transfer, in response to determining that a service switch condition is met, service data to be transmitted between the first terminal and a base station, such that the service data is transmitted between the first terminal and a second terminal, the second terminal is operating as a relay terminal enabling communication between the first terminal and the base station.

In one example, the apparatus further includes a receiving module, where the receiving module is configured that the service switch condition is sent by the base station; or, the service switch condition is specified by a communication protocol.

In one example, the transferring module is further configured to: transfer, in response to determining that radio channel quality between the first terminal and the base station is lower than a first set threshold and that the service switch condition is met, the service data to be transmitted between the first terminal and the base station, such that the service data is transmitted between the first terminal and the second terminal.

In one example, the transferring module is further configured to: transfer, in response to determining that radio channel quality both between the first terminal and the base station as well as between the first terminal and a neighbor base station of the base station is lower than a second set threshold and that the service switch condition is met, the service data to be transmitted between the first terminal and the base station, such that the service data is transmitted between the first terminal and the second terminal.

According to a fourth aspect of the disclosure, an apparatus for transferring a service is provided, performed by a base station, and including a sending module, where

the sending module is configured to send a service switch condition to a first terminal, where

the service switch condition is configured to: trigger the first terminal to transfer, in response to determining that the service switch condition is met, service data to be transmitted between the first terminal and the base station, such that the service data is transmitted between the first terminal and a second terminal, the second terminal is operating as a relay terminal enabling communication between the first terminal and the base station.

According to a fifth aspect of the disclosure, a communication device is provided, including:

a processor; and

a memory for storing executable instructions of the processor; where

the processor is configured to: implement the method described in any example of the disclosure when running the executable instructions.

According to a sixth aspect of the disclosure, a non-transitory computer storage medium is provided. The non-transitory computer storage medium stores a computer executable program. The executable program, when executed by a processor, implements the method described in any example of the disclosure.

In the example of the disclosure, after obtaining the service switch condition, the first terminal may judge by itself whether to switch transmission of the service data according to the service switch condition, instead of passively waiting for the base station to issue a service switch instruction before transferring the transmission of the service data. In this way, compared with the related art, a situation that service transfer cannot be realized due to the failure to receive a radio resource control (RRC) message is reduced, reliability of the service transfer is improved, and stability of a communication network is improved.

1. A method for transferring a service, comprising:
in response to determining that a service switch condition is met, transferring, by a first terminal, service data to be transmitted between the first terminal and a base station, wherein the service data is transmitted between the first terminal and a second terminal, and the second terminal is operating as a relay terminal enabling communication between the first terminal and the base station.

2. The method according to claim 1, wherein
the service switch condition is sent by the base station;
or;
the service switch condition is specified by a communication protocol.

3. The method according to claim 2, further comprising:
in response to determining that radio channel quality between the first terminal and the base station is lower than a first set threshold, and that the service switch condition is met, transferring the service data to be transmitted between the first terminal and the base station, wherein the service data is transmitted between the first terminal and the second terminal.

4. The method according to claim 2, further comprising:
in response to determining that radio channel quality both between the first terminal and the base station as well as between the first terminal and a neighbor base station of the base station is lower than a second set threshold, and that the service switch condition is met, transferring the service data to be transmitted between the first terminal and the base station, wherein the service data is transmitted between the first terminal and the second terminal.

5. The method according to claim 3, wherein the service switch condition at least comprises that:
channel quality between the first terminal and the second terminal is higher than a third set threshold within a predetermined time period.

6. The method according to claim 5, wherein the service switch condition further comprises at least one of:
a distance between the first terminal and the base station is greater than a distance threshold; or
the first terminal is not able to search for a cell whose signal intensity is greater than a signal intensity threshold.

7. The method according to claim 3, further comprising:
receiving information sent by the base station and associated with determining the service switch condition by the first terminal; wherein
the information associated with determining the service switch condition by the first terminal comprises at least one of the following:
first information for determining the channel quality between the first terminal and the second terminal, comprising: information of a first reference signal for measuring the radio channel quality between the first terminal and the second terminal, measuring type information of the first reference signal, and the third set threshold;
second information for determining the radio channel quality between the first terminal and the base station, comprising: information of a second reference signal for measuring the radio channel quality between the first terminal and the base station or the neighbor base station, measuring type information of the second reference signal, the first set threshold and/or the second set threshold; and
information of the predetermined time period, wherein the information of the predetermined time period is configured to determine that the radio channel quality between the first terminal and the base station is lower than the first set threshold within the predetermined time period, or configured to determine that radio channel quality both between the first terminal and the base station as well as between the first terminal and the neighbor base station of the base station is lower than the second set threshold within the predetermined time period, or configured to determine that the channel quality between the first terminal and the second terminal is higher than the third set threshold within the predetermined time period.

8. The method according to claim 7, wherein the first reference signal is one of: a synchronization signal and PBCH block (SSB) reference signal and or a channel-state information reference signal (CSI-RS).

9. The method according to claim 7, wherein the second reference signal is one of: a demodulation reference signal (DMRS) or a channel-state information reference signal (C SI-RS).

10. The method according to claim 7, wherein the measuring type comprises one of: reference signal receiving power (RSRP), reference signal receiving quality (RSRQ) or a channel quality indicator (CQI).

11. The method according to claim 1, further comprising:
receiving mapping relationship information between a first logical channel and a second logical channel sent by the base station; wherein
the first logical channel is a logical channel for wireless communication between the first terminal and the base station, and the second logical channel is a logical channel for wireless communication between the first terminal and the second terminal.

12. (canceled)

13. A method for transferring a service, comprising:
sending, by a base station, a service switch condition to a first terminal, wherein
the service switch condition is configured to: trigger the first terminal to transfer, in response to determining that the service switch condition is met, service data to be transmitted between the first terminal and the base station, wherein the service data is transmitted between the first terminal and a second terminal, and the second terminal is operating as a relay terminal enabling communication between the first terminal and the base station.

14. The method according to claim 13, wherein the service switch condition at least comprises that:
channel quality between the first terminal and the second terminal is higher than a third set threshold within a predetermined time period.

15. The method according to claim 14, wherein the service switch condition further comprises at least one of:
a distance between the first terminal and the base station is greater than a distance threshold; or
the first terminal is not able to search for a cell whose signal intensity is greater than a signal intensity threshold.

16. The method according to claim 13, further comprising:
sending information associated with determining the service switch condition by the first terminal to the first terminal; wherein
the information associated with determining the service switch condition by the first terminal comprises at least one of the following:
first information for determining the channel quality between the first terminal and the second terminal, comprising: information of a first reference signal for measuring the radio channel quality between the first terminal and the second terminal, measuring type information of the first reference signal, and the third set threshold;
second information for determining the radio channel quality between the first terminal and the base station, comprising: information of a second reference signal for measuring the radio channel quality between the first terminal and the base station or the neighbor base station, measuring type information of the second reference signal, a first set threshold and/or a second set threshold; and
information of the predetermined time period, where the information of the predetermined time period is configured to determine that the radio channel quality between the first terminal and the base station is lower than the first set threshold within the predetermined time period, or configured to determine that radio channel quality both between the first terminal and the base station as well as between the first terminal and the neighbor base station of the base station is lower than the second set threshold within the predetermined time period, or configured to determine that the channel quality between the first terminal and the second terminal is higher than the third set threshold within the predetermined time period.

17. The method according to claim 16, wherein the first reference signal is one of: a synchronization signal and PBCH block (SSB) reference signal or a channel-state information reference signal (CSI-RS).

18. The method according to claim 16, wherein the second reference signal is one of: a demodulation reference signal (DMRS) or a channel-state information reference signal (CSI-RS).

19. (canceled)

20. The method according to claim 13, further comprising:
sending mapping relationship information between a first logical channel and a second logical channel to the first terminal, wherein the first logical channel is a logical channel for wireless communication between the first terminal and the base station, and the second logical channel is a logical channel for wireless communication between the first terminal and the second terminal.

21-26. (canceled)

27. A communication device, comprising:
an antenna;
a memory; and
a processor, connected with the antenna and the memory respectively, and configured to:
in response to determining that a service switch condition is met, transfer service data to be transmitted between the first terminal and a base station, wherein the service data is transmitted between the first terminal and a second terminal, and the second terminal is operating as a relay terminal enabling communication between the first terminal and the base station.

28. (canceled)

29. A communication device, comprising:
an antenna;
a memory; and
a processor, connected with the antenna and the memory respectively, and configured to control transceiving of the antenna by executing computer-executable instructions stored on the memory, and be capable of implementing the method provided by claim 13.
